(19) United States
(12) Patent Application Publication
(10) Pub. No.: US 2011/0240334 A1
(43) Pub. Date: Oct. 6, 2011

(54) REDUNDANT WEBBING IN CONJOINED CABLES

(75) Inventor: Noah Montena, Syracuse, NY (US)

(73) Assignee: JOHN MEZZALINGUA ASSOCIATES, INC., East Syracuse, NY (US)

(21) Appl. No.: 12/754,282

(22) Filed: Apr. 5, 2010

(51) Int. Cl. H01B 7/00

(52) U.S. Cl. 174/115

(57) ABSTRACT

Redundant webbing connecting two or more lines in a conjoined cable. In one example embodiment, a conjoined cable includes a first line, a second line, and an integral jacket. The integral jacket includes a first line sleeve surrounding the first line, a second line sleeve surrounding the second line, a first webbing connecting the first line sleeve to the second line sleeve, and a second webbing connecting the first line sleeve to the second line sleeve. The first and second line sleeves and the first and second webbings cooperate to define a passageway between the first and second lines.

### BACKGROUND

Conjoined cables include two or more individual lines, such as cables or wires, combined into a single composite cable. For example, one type of conjoined cable is a messengered coaxial cable in which a coaxial cable is combined with a messenger support wire into a single composite cable. The messenger support wire provides support to the coaxial cable in situations where the coaxial cable aerially spans long distances, such as 75 feet or more. Another example conjoined cable is a standard RCA cable that includes a video line, a left audio line, and a right audio line combined into a single composite cable. Each line of the RCA cable is typically terminated on either end with an RCA plug.

In a typical conjoined cable, the two or more individual lines are generally connected via an outer jacket of the conjoined cable. For example, a single outer jacket can be extruded around two individual lines in a conjoined cable with only a relatively thin webbing of jacket material connecting the two individual lines to one another.

One difficulty with manufacturing a conjoined cable is achieving the proper tear resistance of the webbing. The tear resistance of the webbing is dictated by the type of material from which the webbing is formed, as well as the thickness of the webbing. For example, the webbing of a messengered coaxial cable should be wide enough that the coaxial cable will not inadvertently become separated from the messenger support wire, but not so wide that a cable technician is unable to easily tear a desired portion of the messenger support wire away from the coaxial cable to affix the messenger support wire to an anchor or bracket and to connect the coaxial cable to electronic equipment during equipment setup. In another example, the webbing of an RCA cable should be wide enough that none of the video, left audio, or right audio lines will become inadvertently separated from the other line(s) of the RCA cable, but not so wide that a user is unable to easily tear a desired portion of any line away from the other line(s) to insert the corresponding plug into a jack of audio or visual equipment during equipment setup. Forming the proper thickness of the webbing in a conjoined cable requires very careful process control, which can be expensive and time consuming.

Another difficulty with manufacturing a conjoined cable is dealing with the residual webbing remaining on each individual line of a conjoined cable after the individual lines have been torn apart at the webbing. For example, the residual webbing of a messengered coaxial cable can interfere with the termination of the coaxial cable. In particular, terminating the coaxial cable by attaching a connector to the coaxial cable generally requires that the outside jacket of the coaxial cable be round and smooth. Therefore, the residual webbing left over on the outside jacket may need to be cut or shaved off of the area to which the connector is to be attached. This cutting or shaving inherently risks cutting through the jacket and other internal layers of the coaxial cable, thus damaging the cable and degrading its performance. It addition, even without cutting all the way through the jacket, too much of the jacket may be shaved off of the connector area which can compromise the seal of the subsequently attached connector. Failing to remove excess residual webbing can likewise compromise the seal of the subsequently attached connector.

### SUMMARY OF SOME EXAMPLE EMBODIMENTS

In general, example embodiments of the present invention relate to redundant webbing connecting two or more lines in a conjoined cable. The example redundant webbing disclosed herein has proper tear resistance such that the lines of the conjoined cable will not inadvertently become separated from one another but can easily be torn apart from one another by a technician during installation of the conjoined cable. The example redundant webbing disclosed herein enables proper tear resistance of the webbing to be achieved relatively easily. In addition, the example redundant webbing disclosed herein minimizes the amount of residual webbing remaining on each individual line of a conjoined cable after the individual lines have been torn apart at the webbing, which can facilitate termination of the individual lines of the conjoined cable.

In one example embodiment, a conjoined cable includes a first line, a second line, and an integral jacket. The integral jacket includes a first line sleeve surrounding the first line, a second line sleeve surrounding the second line, a first webbing connecting the first line sleeve to the second line sleeve, and a second webbing connecting the first line sleeve to the second line sleeve. The first and second line sleeves and the first and second webbings cooperate to define a passageway between the first and second lines.

In another example embodiment, a messengered coaxial cable includes a coaxial cable, a messenger support wire, and an integral jacket. The coaxial cable includes a center conductor configured to propagate a signal, a dielectric surrounding the center conductor, and an outer conductor surrounding the dielectric. The integral jacket includes a cable sleeve surrounding the coaxial cable, a wire sleeve surrounding the messenger support wire, a first webbing connecting the cable sleeve to the wire sleeve, and a second webbing connecting the cable sleeve to the wire sleeve. The cable sleeve, wire sleeve, and first and second webbings cooperate to define a passageway positioned between the coaxial cable and the messenger support wire.

In yet another example embodiment, an RCA cable includes first, second, and third lines and an integral jacket. The integral jacket includes a first line sleeve surrounding the first line, a second line sleeve surrounding the second line, a third line sleeve surrounding the third line, a first webbing connecting the first line sleeve to the second line sleeve, a second webbing connecting the first line sleeve to the second line sleeve, a third webbing connecting the second line sleeve to the third line sleeve, and a fourth webbing connecting the second line sleeve to the third line sleeve. The first and second line sleeves and the first and second webbings cooperate to define a first passageway between the first and second lines. The second and third line sleeves and the third and fourth webbings cooperate to define a second passageway between the third and fourth lines.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1A is a perspective view of an example messengered coaxial cable that terminates on either end with an example connector;

FIG. 1B is a perspective view of a portion of the messengered coaxial cable of FIG. 1A with portions of each layer cut away;

FIG. 1C is a cross-sectional view of the example messengered coaxial cable of FIG. 1B having a redundant webbing configuration;

FIG. 1D is a cross-sectional view of an alternative messengered coaxial cable having an alternative redundant webbing configuration;

FIG. 1E is a cross-sectional view of another alternative messengered coaxial cable having another alternative redundant webbing configuration;

FIG. 2A is a perspective view of an example RCA cable having three lines with each line terminating on either end with an RCA plug; and

FIG. 2B is a cross-sectional view of the example RCA cable of FIG. 2A having a pair of redundant webbing configurations.

### DETAILED DESCRIPTION OF SOME EXAMPLE EMBODIMENTS

Example embodiments of the present invention relate to redundant webbing connecting two or more cables or wires in a conjoined cable. In the following detailed description of some example embodiments, reference will now be made in detail to example embodiments of the present invention which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. Example Messengered Coaxial Cables

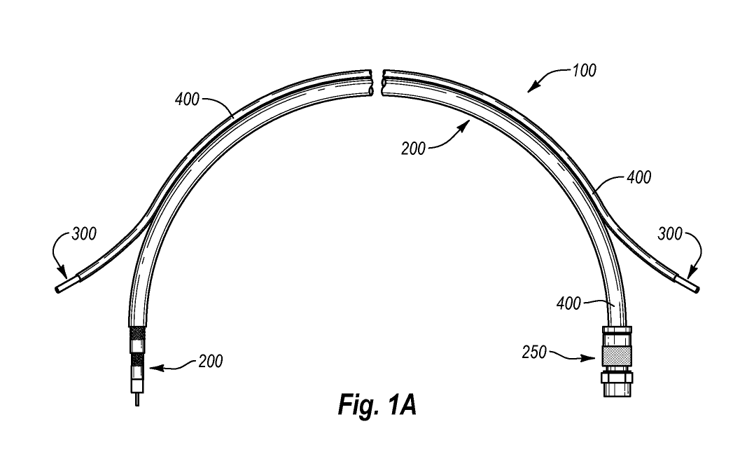

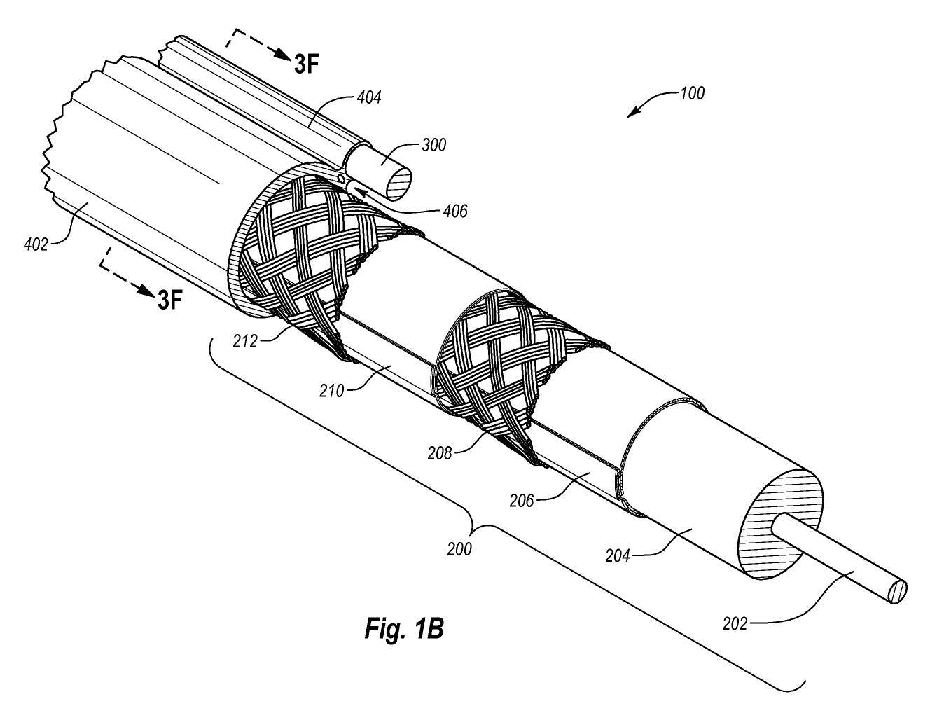

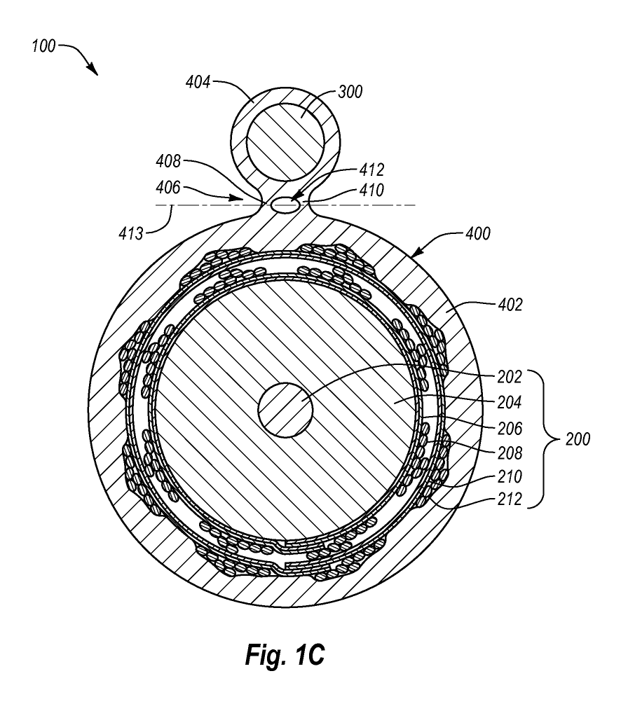

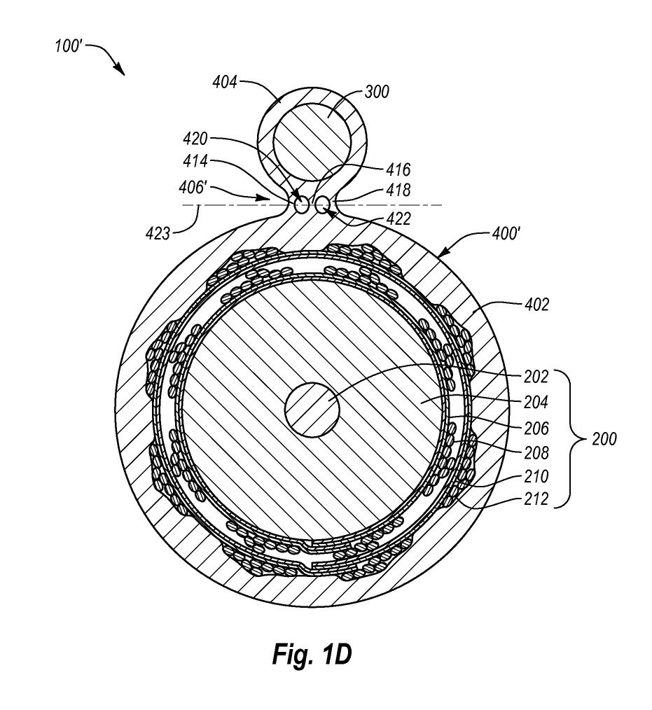

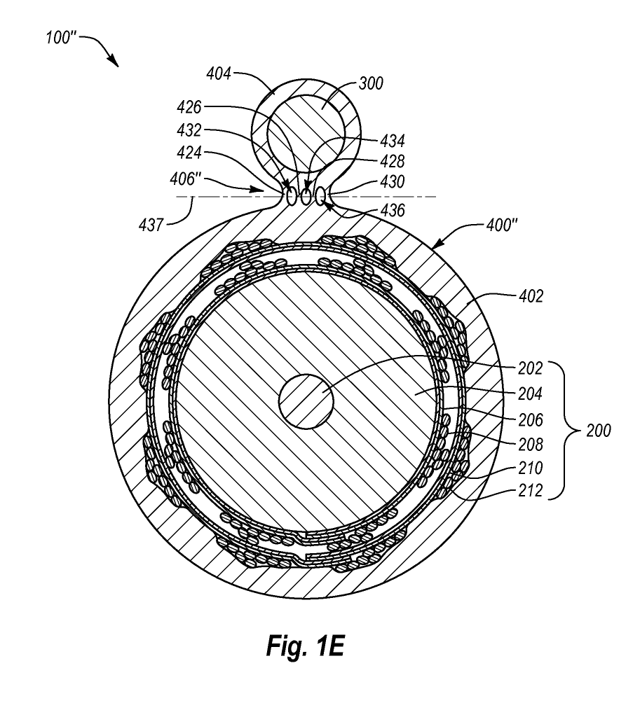

With reference first to FIG. 1A, an example messengered coaxial cable 100 is disclosed. The example messengered coaxial cable 100 is one example of a conjoined cable because it includes both an example coaxial cable 200 and an example messenger support wire 300 combined into a single composite cable via an integral jacket 400. As disclosed in FIG. 1A, the example coaxial cable 200 of the example messengered coaxial cable 100 is terminated on the right side of FIG. 1A with an example connector 250. Although the connector 250 is disclosed in FIG. 1A as F-type male connector, it is understood that example coaxial cable 200 can also be terminated with other types of male and/or female connectors (not shown).

With continuing reference to FIG. 1A, and with reference also to FIGS. 1B and 1C, additional aspects of the example messengered coaxial cable 100 are disclosed. While the example coaxial cable 200 is a 75 Ohm coaxial cable, it is understood that other types of messengered coaxial cable, such as 75 Ohm coaxial cable, can benefit from the redundant webbing disclosed herein.

As disclosed in FIGS. 1B and 1C, the example coaxial cable 200 of the messengered coaxial cable 100 is a quad-shield coaxial cable that generally includes a center conductor 202 surrounded by a dielectric 204, a first conductive tape 206 surrounding the dielectric 204, a first conductive braid 208 surrounding the first conductive tape 206, a second conductive tape 210 surrounding the first conductive braid 208, a second conductive braid 212 surrounding the second conductive tape 210. As used herein, the phrase “surrounded by” refers to an inner layer generally being encased by an outer layer. However, it is understood that an inner layer may be “surrounded by” an outer layer without the inner layer being immediately adjacent to the outer layer. The term “surrounded by” thus allows for the possibility of intervening layers. Each of these components of the example coaxial cable 200 will now be discussed in turn.

The center conductor 202 is positioned at the core of the example coaxial cable 200. The center conductor 202 is configured to carry a range of electrical current (amperes) as well as propagate an RF/electronic digital signal. In some example embodiments, the center conductor 202 is formed from solid copper, copper-clad aluminum (CCA), copper-clad steel (CCS), or silver-coated copper-clad steel (SCCCS), although other conductive materials are possible. For example, the center conductor 202 can be formed from any type of conductive metal or alloy. In addition, the center conductor 202 can be solid, hollow, stranded, corrugated, plated, or clad, for example.

The dielectric 204 surrounds the center conductor 202, and generally serves to support and insulate the center conductor 202 and the first conductive tape 206. Although not shown in the figures, a bonding agent, such as a polymer, can be employed to bond the dielectric 204 to the center conductor 202. In some example embodiments, the dielectric 204 can be, but is not limited to, taped, solid, or foamed polymer or fluoropolymer. For example, the dielectric 204 can be foamed polyethylene (PE).

The first conductive tape 206 surrounds the dielectric 204 and generally serves to minimize the ingress and egress of high frequency electromagnetic radiation to/from the center conductor 202. For example, in some applications, the first conductive tape 206 can shield against electromagnetic radiation with a frequency greater than or equal to about 50 MHz. The first conductive tape 206 is a laminate tape that can include, but is not limited to, the following layers: aluminum/polymer, bonding agent/aluminum/polymer, bonding agent/aluminum/polymer/aluminum, or aluminum/polymer/aluminum, for example. It is understood, however, that the discussion herein of tape is not limited to tape having any particular combinations of layers.

The first conductive braid 208 surrounds the first conductive tape 206. The first conductive braid 208 generally serves to minimize the ingress and egress of low frequency electromagnetic radiation to/from the center conductor 202. For example, in some applications, the first conductive braid 208 can shield against electromagnetic radiation with a frequency less than about 50 MHz. In addition, the first conductive braid 208 also serves to give structural support to, and thereby strengthen, the coaxial cable 200. The first conductive braid 208 can be formed from inter-woven, fine gauge aluminum or copper wires, such as 34 American wire gauge (AWG) wires, for example. It is understood, however, that the discussion herein of braid is not limited to braid formed from any particular type or size of wire.

The second conductive tape 210 surrounds the first conductive braid 208 and is identical in form and function to the first conductive tape 206. The second conductive braid 212 surrounds the second conductive tape 210 and is identical in form and function to the first conductive braid 208.

The messenger support wire 300 of the messengered coaxial cable 100 runs adjacent to and parallel to the coaxial cable 200. The messenger support wire 300 can be formed from any type of support material such as galvanized, carbon steel wire, for example. The messenger support wire 300 can provide support to the coaxial cable 200 in situations where the coaxial cable 200 aerially spans long distances, such as 75 feet or more.

The coaxial cable 200 and the messenger support wire 300 are surrounded by and connected together with an integral jacket 400. The jacket 400 surrounds the coaxial cable 200 and the messenger support wire 300, and generally serves to protect the internal components of the messengered coaxial cable 100 from external contaminants, such as dust, moisture, and oils, for example. In a typical embodiment, the jacket 400 also functions to limit the bending radius of the messengered coaxial cable 100 to prevent kinking, and functions to protect the messengered coaxial cable 100 (and its internal components) from being crushed or otherwise misshapen from an external force. The example jacket 400 can be formed from a variety of materials such as, but not limited to, polyethylene (PE), high-density polyethylene (HDPE), low-density polyethylene (LDPE), linear low-density polyethylene (LLDPE), flame retardant polyvinyl chloride (flame retardant PVC), or some combination thereof.

As disclosed in FIGS. 1B and 1C, the integral jacket 400 includes a cable sleeve 402 surrounding the coaxial cable 200, a wire sleeve 404 surrounding the messenger support wire 300, and a redundant webbing configuration 406 connecting the cable sleeve 402 to the wire sleeve 404. As disclosed in FIG. 1C, the redundant webbing configuration 406 includes a first webbing 408 and a second webbing 410. The cable sleeve 402, wire sleeve 404, and first and second webbings 408 and 410 cooperate to define a passageway 412 positioned between the coaxial cable 200 and the messenger support wire 300.

As disclosed in FIG. 1C, the narrowest thickness of the first and second webbings 408 and 410 is less than the narrowest thickness of the cable and wire sleeves 402 and 404, although relative thicknesses varying from those disclosed in FIG. 1C are also possible. As also disclosed in FIG. 1C, the first and second webbings 408 and 410 are shaped to tear along a tearing path 413 that passes through the passageway 412.

With reference now to FIG. 1D, an alternative messengered coaxial cable 100′ is disclosed with a jacket 400′ having an alternative redundant webbing configuration 406′. In particular, instead of two webbings, the redundant webbing configuration 406′ includes three webbings, namely, a first webbing 414, a second webbing 416, and a third webbing 418. The cable sleeve 402 and wire sleeve 404 cooperate with the first and second webbings 414 and 416 to define a first passageway 420 and with the second and third webbings 416 and 418 to define a second passageway 422. Both passageways 420 and 422 are positioned between the coaxial cable 200 and the messenger support wire 300.

As disclosed in the comparison of FIGS. 1C and 1D, the inclusion of three webbings instead of only two webbings enables each of the three webbings to be formed more narrowly without compromising the combined strength of the webbings. As disclosed in FIG. 1D, the narrowest thickness of the first, second, and third webbings 414, 416, and 418 is less than the narrowest thickness of the cable and wire sleeves 402 and 404, although relative thicknesses varying from those disclosed in FIG. 1D are also possible. As also disclosed in FIG. 1D, the first, second, and third webbings 414, 416, and 418 are shaped to tear along a tearing path 423 that passes through the first and second passageways 420 and 422.

With reference now to FIG. 1E, another alternative messengered coaxial cable 100″ is disclosed with a jacket 400″ having another alternative redundant webbing configuration 406″. In particular, instead of three webbings, the redundant webbing configuration 406″ includes four webbings, namely, a first webbing 424, a second webbing 426, a third webbing 428, and a fourth webbing 430. The cable sleeve 402, wire sleeve 404 cooperate with the first and second webbings 424 and 426 to define a first passageway 432, with the second and third webbings 426 and 428 to define a second passageway 434, and with the third and fourth webbings 428 and 430 to define a third passageway 436. All three passageways 432, 434, and 436 are between the coaxial cable 200 and the messenger support wire 300.

As disclosed in the comparison of FIGS. 1D and 1E, the inclusion of four webbings instead of only three webbing enables each of the four webbings to be formed even more narrowly without compromising the combined strength of the webbings. As disclosed in FIG. 1E, the narrowest thickness of the first, second, third and fourth webbings 424, 426, 428, and 430 is less than the narrowest thickness of the cable and wire sleeves 402 and 404, although relative thicknesses varying from those disclosed in FIG. 1E are also possible. As also disclosed in FIG. 1E, the first, second, third and fourth webbings 424, 426, 428, and 430 are shaped to tear along a tearing path 437 that passes through the first, second, and third passageways 432, 434, and 436.

As disclosed in FIGS. 1B-1E, the example jackets 400, 400′, and 400″ are each integrally formed as a single extruded material. The integral formation can be accomplished by feeding the coaxial cable 200 and the messenger support wire 300 through an extruder where the integral jacket 400, 400′, or 400″ is applied so as to surround the coaxial cable 200 and the messenger support wire 300. The extruder may include a die or dies configured to form the passageway 412 in the jacket 400, the passageways 420 and 422 in the jacket 400′, or the passageways 432, 434, and 436 in the jacket 400″.

In some example embodiments, the passageways disclosed herein can be filled with a gas during cable formation. For example, a gas may be injected into the passageways, through a tip of the die for example, in order to prevent the passageways from collapsing while the corresponding integral jacket 400, 400′, or 400″ cools and hardens. This gas may be an inert gas such as helium, neon, argon, krypton, xenon, carbon dioxide, nitrogen, or some combination thereof. Alternatively, this cable formation step may be omitted altogether where the passageways are maintained using methods other than filling with a gas while the jacket 400, 400′, or 400″ is cooled and hardened.

Advantageously, each of the redundant webbing configurations 406, 406′, and 406″ is formed to have proper tear resistance such that the coaxial cable 200 and the messenger support wire 300 of the messengered coaxial cable 100 will not inadvertently become separated from one another, but can easily be torn apart from one another during installation of the messengered coaxial cable 100. The example redundant webbing configurations 406, 406′, and 406″ disclosed herein enable proper tear resistance of the webbing to be achieved relatively easily. In particular, the individual thicknesses of the redundant webbings can vary more than with single webbings. Thus, forming the individual thicknesses of the redundant webbings requires less careful process control than with single webbings, which can save expense and consume less time.

In addition, the example redundant webbing disclosed herein configurations 406, 406′, and 406″ reduce the amount of residual webbing remaining on the cable sleeve 402 of the coaxial cable 200 after the coaxial cable 200 has been torn apart at the webbing. This reduction in the amount of residual webbing can facilitate termination of the coaxial cable 200, with the connector 250 of FIG. 1A for example, by reducing or eliminating entirely the need to cut or shave off residual webbing from the area to which the connector is to be attached, thus avoiding the inherent risk of cutting through the cable sleeve 402 and other internal layers of the coaxial cable 200.

### II. Example RCA Cable

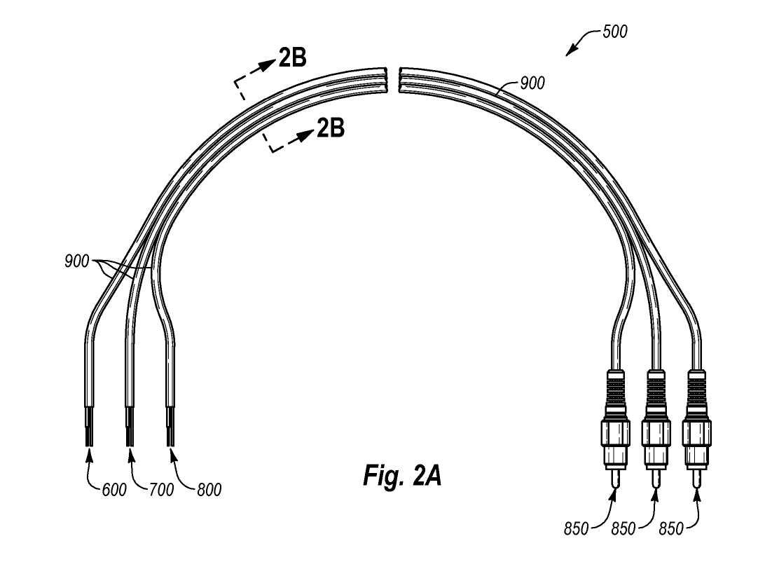

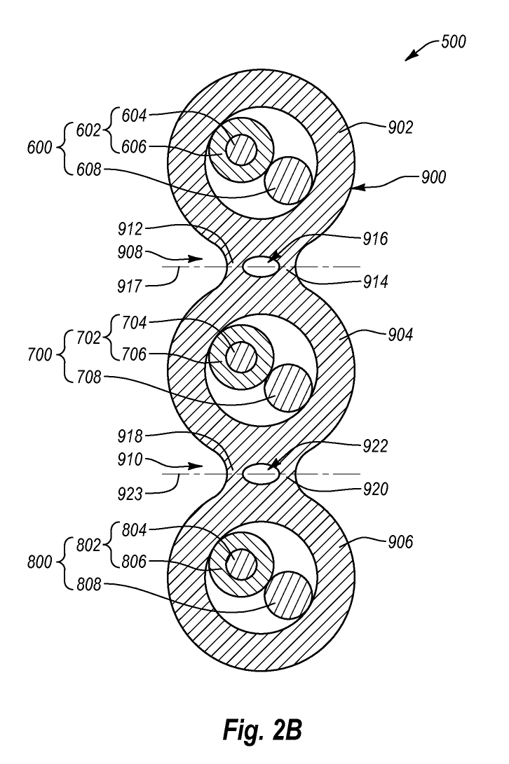

With reference now to FIG. 2A, an example RCA cable 500 is disclosed. The example RCA cable 500 is another example of a conjoined cable because it includes first, second, and third lines 600, 700, and 800 combined into a single composite cable via an integral jacket 900. As disclosed in FIG. 2A, each of the first, second, and third lines 600, 700, and 800 is terminated on the right side of FIG. 2A with an example connector 850. Although the connector 850 is disclosed in FIG. 2A as an RCA male connector, it is understood that each line can also be terminated with other types of male and/or female connectors (not shown).

With continuing reference to FIG. 2A, and with reference also to FIG. 2B, additional aspects of the example RCA cable 500 are disclosed. As disclosed in FIG. 2B, each line of the example RCA cable 500 generally includes a signal wire 602, 702, or 802, each made up of a signal conductor 604, 704, or 804 surrounded by an insulating layer 606, 706, or 806, respectively. Each line of the example RCA cable 500 includes a ground wire 608, 708, or 808. Each signal wire 602, 702, or 802 may be configured to carry a particular type of signal. For example, the signal wire 602 may be configured to carry a video signal, the signal wire 702 may be configured to carry a left audio signal, and the signal wire 802 may be configured to carry a right audio signal.

The first, second, and third lines 600, 700, and 800 are surrounded by and connected together with the integral jacket 900. The jacket 900 surrounds the first, second, and third lines 600, 700, and 800, and generally serves to protect the internal components of the example RCA cable 500 from external contaminants, such as dust, moisture, and oils, for example. The jacket 900 also functions to limit the bending radius of the RCA cable 500 to prevent kinking, and functions to protect the RCA cable 500 (and its internal components) from being crushed or otherwise misshapen from an external force. The example jacket 900 can be formed from a variety of materials including any material or combination of materials listed above in connection with the jacket 400.

As disclosed in FIG. 2B, the integral jacket 900 includes a first sleeve 902 surrounding the first line 600, a second sleeve 904 surrounding the second line 700, a third sleeve 906 surrounding the third line 800, a first redundant webbing configuration 908 connecting the first sleeve 902 to the second sleeve 904, and a second redundant webbing configuration 910 connecting the second sleeve 904 to the third sleeve 906. As disclosed in FIG. 2B, the first redundant webbing configuration 908 includes a first webbing 912 and a second webbing 914. The first and second sleeves 902 and 904 and the first and second webbings 912 and 914 cooperate to define a first passageway 916 positioned between the first and second lines 600 and 700. Similarly, the second redundant webbing configuration 910 includes a third webbing 918 and a fourth webbing 920. The second and third sleeves 904 and 906 and the third and fourth webbings 918 and 920 cooperate to define a second passageway 922 positioned between the second and third lines 700 and 800.

As disclosed in FIG. 2B, the narrowest thickness of the first, second, third and fourth webbings 912, 914, 918, and 920 is less than the narrowest thickness of the sleeves 902, 904, and 906, although relative thicknesses varying from those disclosed in FIG. 2B are also possible. As also disclosed in FIG. 2B, the first and second webbings 912 and 914 are shaped to tear along a first tearing path 917 that passes through the first passageway 916, and the third and fourth webbings 918 and 920 are shaped to tear along a second tearing path 923 that passes through the second passageway 922.

As disclosed in FIG. 2B, the example jacket 900 is integrally formed as a single extruded material. The integral formation can be accomplished by feeding the first, second, and third lines 600, 700, and 800 through an extruder where the integral jacket 900 is applied so as to surround the first, second, and third lines 600, 700, and 800. The extruder may include a die or dies configured to form the passageways 916 and 922 in the integral jacket 900.

Each of the redundant webbing configurations 908 and 910 is formed to have proper tear resistance such that the first, second, and third lines 600, 700, and 800 will not inadvertently become separated from one another, but can easily be torn apart from one another during installation of the RCA cable 500. The example redundant webbing configurations 908 and 910 disclosed herein enable proper tear resistance of the webbing to be achieved relatively easily. In particular, the individual thicknesses of the redundant webbings can vary more than with single webbings. Thus, forming the individual thicknesses of the redundant webbings requires less careful process control than with single webbings, which can save expense and consume less time.

### III. Alternative Embodiments

Although the example embodiments are described in the context of a messengered coaxial cable and an RCA cable with three lines, it is understood that other conjoined cable configurations may likewise benefit from the redundant webbing disclosed herein. Further, various types of conjoined cable lines, such as coaxial cable, electrical lines, power lines, and fiber optic cable, may benefit from the redundant webbing disclosed herein. For example, any of the following conjoined cables can include redundant webbing: standard-shield messengered coaxial cable (where the outer conductor includes one braid layer and one tape layers) and tri-shield messengered cable (where the outer conductor includes one braid layer and two tape layers), dual coaxial cable (where two coaxial cables are combined into a single composite cable), coaxial/power cable (where a coaxial cable and an electrical power cable are combined into a single composite cable), coaxial/RCA cable (where a coaxial cable and an RCA cable are combined into a single composite cable), an RCA cable with only two lines (such as a right audio line and a left audio line) or more than three lines, or any combination thereof.

In addition, where a conjoined cable includes three or more lines combined into a single composite cable, one webbing configuration of the conjoined cable may be a non-redundant webbing configuration with only a single webbing, while one or more other webbing configurations of the conjoined cable may be redundant webbing configurations each having two or more webbings. Further, a single conjoined cable may include one redundant webbing configuration with a first number of redundant webbings and another redundant webbing configuration with a second different number of redundant webbings.

Also, although example embodiments are described in the context of conjoined cables with lines that run parallel to one another, it understood that conjoined cables with lines that twist around one another may likewise benefit from the redundant webbing disclosed herein. Further, although example embodiments are described in the context of conjoined cables with webbing that runs the entire length of the conjoined cables, it understood that conjoined cables with webbing that runs only periodically along the length of the conjoined cables may similarly benefit from the redundant webbing disclosed herein.

Further, although the tearing paths 413, 423, 437, 917, and 923 are disclosed in the Figures as being substantially tangential to the surrounding lines, it is understood that the respective webbings can instead be shaped such that they tend to tear along a path that is not tangential to the surrounding lines. Further, it is understood that the angle between the tearing paths 413, 423, 437, 917, and 923 and the surrounding lines may be uniform or may vary along the length of the respective conjoined cables. Also, although the tearing paths 423 and 437 are disclosed in FIGS. 1D and 1E as linear tearing paths, it is understood that the tearing paths 423 and 427 may instead be non-linear tearing paths due to these tearing paths passing through more than two tearing points at any given position along the alternative messengered coaxial cables 100′ and 100″, respectively. Accordingly, the disclosure of tearing paths herein is not limited to the example tangential and linear tearing paths disclosed in the Figures.

Also, although the passageways 412, 420, 422, 432, 434, 436, 916, and 922 are each disclosed in the Figures as having a substantially oval-shaped cross section, it is understood that any of these passageways can instead have a cross-section with a variety of other shapes such as triangular, square, rectangular, circular, or diamond-shaped. Further, it is understood that passageways with cross-sections having well-defined corners, such as squares or diamonds, may help contribute to a well-defined tearing path in the surrounding webbings. Accordingly, the disclosure of passageways defined between webbings herein is not limited to the example oval-shaped cross section disclosed in the Figures.

The example embodiments disclosed herein may be embodied in other specific forms. The example embodiments disclosed herein are to be considered in all respects only as illustrative and not restrictive.

What is claimed is:

1. A conjoined cable comprising:
a first line;
a second line;
an integral jacket comprising:
a first line sleeve surrounding the first line;
a second line sleeve surrounding the second line;
a first webbing connecting the first line sleeve to the second line sleeve; and
a second webbing connecting the first line sleeve to the second line sleeve, wherein the first and second line sleeves and the first and second webbings cooperate to define a passageway between the first and second lines.

2. The conjoined cable as recited in claim 1, wherein the first line comprises a coaxial cable.

3. The conjoined cable as recited in claim 2, wherein the second line comprises a messenger support wire.

4. The conjoined cable as recited in claim 2, wherein the second line comprises a second coaxial cable.

5. The conjoined cable as recited in claim 1, wherein the first line comprises a left audio line and the second line comprises a right audio line.

6. The conjoined cable as recited in claim 1, wherein the narrowest thickness of the first and second webbings is less than the narrowest thickness of the first and second line sleeves.

7. The conjoined cable as recited in claim 1, wherein the integral jacket comprises polyethylene (PE), high-density polyethylene (HDPE), low-density polyethylene (LDPE), linear low-density polyethylene (LLDPE), flame retardant polyvinyl chloride (PVC), or some combination thereof.

8. The conjoined cable as recited in claim 1, wherein the first and second webbings are shaped to tear along a tearing path that passes through the passageway.

9. A messengered coaxial cable comprising:
a coaxial cable comprising:
a center conductor configured to propagate a signal;
a dielectric surrounding the center conductor; and
an outer conductor surrounding the dielectric;
a messenger support wire; and
an integral jacket comprising:
a cable sleeve surrounding the coaxial cable;
a wire sleeve surrounding the messenger support wire;
a first webbing connecting the cable sleeve to the wire sleeve; and
a second webbing connecting the cable sleeve to the wire sleeve,
wherein the cable sleeve, the wire sleeve, and the first and second webbings cooperate to define a passageway positioned between the coaxial cable and the messenger support wire.

10. The messengered coaxial cable as recited in claim 9, wherein the outer conductor comprises:
one or more tape layers; and
one or more braid layers, each braid layer being adjacent to a tape layer.

11. The messengered coaxial cable as recited in claim 9, wherein the narrowest thickness of the first and second webbings is less than the narrowest thickness of the cable and wire sleeves.

12. The messengered coaxial cable as recited in claim 9, wherein the first and second webbings are shaped to tear along a path that passes through the passageway.

13. The messengered coaxial cable as recited in claim 9, further comprising a third webbing connecting the cable sleeve to the wire sleeve, wherein the cable sleeve, wire sleeve, and second and third webbings cooperate to define a second passageway positioned between the coaxial cable and the messenger support wire.

14. The messengered coaxial cable as recited in claim 13, further comprising a fourth webbing connecting the cable sleeve to the wire sleeve, wherein the cable sleeve, wire sleeve, and third and fourth webbings cooperate to define a third passageway positioned between the coaxial cable and the messenger support wire.

15. The messengered coaxial cable as recited in claim 9, wherein the jacket comprises PE, HDPE, LDPE, LLDPE, flame retardant PVC, or some combination thereof.

16. An RCA cable comprising:
first, second, and third lines; and
an integral jacket comprising:
a first line sleeve surrounding the first line;
a second line sleeve surrounding the second line;
a first webbing connecting the first line sleeve to the second line sleeve;
a second webbing connecting the first line sleeve to the second line sleeve, wherein the first and second line sleeves and the first and second webbings cooperate to define a first passageway between the first and second lines;
a third line sleeve surrounding the third line;
a third webbing connecting the second line sleeve to the third line sleeve; and
a fourth webbing connecting the second line sleeve to the third line sleeve, wherein the second and third line sleeves and the third and fourth webbings cooperate to define a second passageway between the third and fourth lines.

17. The RCA cable as recited in claim 16, wherein the first, second, and third lines each comprises one of a video line, a left audio line, or a right audio line and each line of the RCA cable is terminated on one or both ends with an RCA plug.

18. The RCA cable as recited in claim 16, wherein the jacket comprises PE, HDPE, LDPE, LLDPE, flame retardant PVC, or some combination thereof.

19. The RCA cable as recited in claim 16, wherein the narrowest thickness of the first, second, third, and fourth webbings is less than the narrowest thickness of the line sleeves.

20. The RCA cable as recited in claim 16, wherein:
the first and second webbings are shaped to tear along a first path that passes through the first passageway; and
the third and fourth webbings are shaped to tear along a second path that passes through the second passageway.
